(19) United States
(12) Patent Application Publication
(10) Pub. No.: US 2022/0032339 A1
(43) Pub. Date: Feb. 3, 2022

(54) METHOD FOR APPLYING AND MOULDING A MOULDABLE COATING COMPOUND

(71) Applicant: Kay-Johannes WREDE, Hamburg (DE)

(72) Inventor: Kay-Johannes WREDE, Hamburg (DE)

(21) Appl. No.: 17/277,114

(22) PCT Filed: Sep. 18, 2019
(86) PCT No.: PCT/EP2019/075047

§ 371 Date: Mar. 17, 2021

(30) Foreign Application Priority Data
Sep. 18, 2018 (DE) 10 2018 122 898.8

(51) Int. Cl. B05D 3/12; B05D 1/02; B63B 3/00

(52) U.S. Cl. CPC B05D 3/12; B63B 3/00; B05D 1/02

(57) ABSTRACT

The invention relates to a method for applying and molding a moldable coating compound (4), which is viscous during a predetermined application period and is cured once the application period has elapsed, onto a subsurface (2), in particular the outer skin of a watercraft, having the following steps: During the application period, the coating compound (4) is applied onto the subsurface (2); during the application period, a flexible planar substrate (6) is placed onto the applied coating compound (4); and, during the application period, a molding tool (8) is brought temporarily to bear on the substrate (6) to bring the surface (4a) of the coating compound (4) into a required shape.

The invention relates to a method for applying and molding, particularly smoothing, a moldable coating compound, which is viscous during a predetermined application period and is cured once the application period has elapsed, onto a subsurface, in particular the outer skin of a watercraft.

In many applications, it is desirable for the coating compound to be finished, after application onto the subsurface, such that its surface is brought and/or smoothed into a required shape. This is particularly the case when the subsurface has an unevenness which then must be compensated for in order to obtain a required or smooth finish. To this end, preferably a suitable filling compound or filler is used as the coating compound.

Specifically in yacht construction, the production of a smooth outer skin with smooth strakes is especially desired, because unevenness in the outer skin has a very negative affect on the appearance of the yacht. This particularly applies to high-quality super yachts, where a perfect finish is required for the outer skin and for the other surfaces. Particularly during production of the hull, production-related unevenness cannot be avoided, which then must be compensated for by applying a filling compound or filler suitable for this purpose. One problem in this case is particularly that the hull, just as possibly further components, does not form any flat surface but is instead curved such that a required shape and/or curvature progression and/or required curves must be observed when applying the filling compound or filler to compensate for the unevenness. In other words, particularly during refinishing, the filling compound or filler must be meticulously applied such that the surface follows the required curvature progression and thus obtains a finish which has particularly continuous strakes.

After application onto the subsurface, the coating compound is finished and particularly displaced and distributed, during the application period in which it is still viscous and thus can be finished, with the aid of a molding tool in order to give the surface of the coating compound the required shape and particularly to achieve a smooth finish. Particularly in order to achieve a smooth surface, a smoothing tool such as, for example, a filler blade, a scraper, or a trowel is used as the molding tool, in which, for very large and long surfaces such as particularly the outer skin of super yachts, preferably a very long scraper is used which is several meters wide. However, it is disadvantageous that parts of the coating compound on its surface adhere to the backside of the molding tool and are picked up by the tool. This phenomenon means that parts of the coating compound are pulled back out of the surface behind the molding tool and this results as well in air holes or air pockets.

An object of the present invention is to propose a solution in which the previously described disadvantages when using a molding tool are avoided.

In order to achieve this object, a method is proposed according to the invention for applying and molding a moldable coating compound, which is viscous during a predetermined application period and is cured once the application period has elapsed, onto a subsurface, in particular the outer skin of a watercraft, with the following steps:

I) applying the coating compound to the subsurface during the application period,
II) placing a flexible, planar substrate onto the applied coating compound during the application period, and
III) bringing a molding tool temporarily to bear on the substrate in order to bring the surface of the coating compound into a required shape during the application period.

The planar substrate placed on the coating compound according to the invention in Step II during the application period effectively prevents parts of the coating compound from adhering to the molding tool and being drawn from the surface of the coating compound in subsequent Step III. This is because the planar substrate used according to the invention forms a protective or separating layer on the surface of the coating compound applied to the subsurface as relates to the molding tool and essentially does not exhibit any adhesion properties on its surface such that the molding tool is placed in detachable contact with the surface of the substrate and can also then be easily removed therefrom without adhering thereto. In addition, because the planar substrate is formed flexibly according to the invention, the molding tool has the same effect as in the prior art in that the applied coating compound can be impacted by the flexible, planar substrate with differing pressure, as a function of the respective unevenness in the subsurface, with the aid of the molding tool, until the surface of the coating compound is in the required shape. In particular, the coating compound can be moved back-and-forth during the application period as often as desired with the aid of the molding tool, as long as it has not yet started to cure, and thus be smoothed until it obtains the correct shape. Thus, the surface of the coating compound can also easily be adapted to a curved progression of the subsurface or to curves formed in the subsurface (for example, to attachment parts such as the rub rails on a yacht). Due to its separating effect, the flexible, planar substrate used according to the invention prevents, in an advantageous manner, the development of undesired air holes or air pockets. All things considered, a coating compound applied to the subsurface can be easily made into a required shape with the aid of the method according to the invention; this shape may have, and particularly also smoothen, for example, a curvature or curves or even points of discontinuity.

Preferred statements and refinements of the invention are indicated in the dependent claims.

Expediently, filling compound or filler is used as the coating compound.

Particularly when used in moisture-containing or water-containing environments, a material having an epoxy resin should be used as the coating compound. Because epoxy resin does not exhibit any substantial shrinkage behavior but is also water-resistant and thus forms an effective vapor barrier, epoxy resin is particularly used in yacht construction.

Preferably, the coating compound is applied to the subsurface in Step I substantially without air pockets, to which end preferably the coating compound is sprayed or discharged onto the subsurface.

A preferred application case is to compensate for unevenness in the subsurface with the aid of the coating compound and thus to smooth the surface of the coating compound such that preferably a smoothing tool is used as the molding tool, particularly in such cases.

In order to especially effectively give the surface of the coating compound applied to the subsurface the required shape and/or to smooth the surface, the molding tool should be moved along the substrate in Step III, and that is preferably back-and-forth and particularly in a first direction in this case and in a second direction which is oriented transversely, substantially at a right angle, as relates to the first direction.

Preferably, an elongated body, which is moved in a direction transversely, preferably substantially at a right angle, as relates to its longitudinal extension, should be used as the molding tool in order to especially effectively smooth the surface of the coating compound applied to the subsurface, particularly in this manner.

If a coating compound which can be cured under the effect of heat is used as the moldable coating compound, it is advantageous to use a substrate having a heating medium as the flexible, planar substrate. In this preferred embodiment, the flexible, planar substrate used according to the invention thus not only takes on the function of a protective or separating layer covering the surface of the coating compound for easy finishing by the molding tool, but also simultaneously the function of providing, in an advantageous manner, the heat required for effective curing of the coating compound. Activation of the heating medium in the flexible, planar substrate during the application period should expediently take place in Step II and/or between Step II and Step III and/or in Step III and/or following Step III. In one advantageous refinement, the heating media have electrical heating wires which are connected to a voltage source outside of the substrate.

Preferably, a substrate permeable to air is used as the flexible, planar substrate. Even if the flexible, planar substrate can thusly be easily placed on the surface of the coating compound applied to the subsurface in Step II such that any air pockets can be easily prevented, the use of a substrate permeable to air ensures that any air enclosed, contrary to expectations, between the surface of the coating compound and the bottom of the flexible, planar substrate can escape through the substrate, no later than during finishing with the aid of the molding tool in Step III. In this manner, it can be ensured that any actual air pockets are prevented.

Preferably, a perforated substrate is used as the flexible, planar substrate. The substrate is provided a special structure by means of the perforation which leads to improved adhesion properties and which is transferred to the surface of the still-viscous coating compound in Step II when the substrate is placed, the surface thereby obtaining a corresponding structure.

Particularly when a material having an epoxy resin is used as the coating compound, it is advantageous to use a substrate which absorbs liquids as the flexible, planar substrate, which then absorbs the liquid resin such that resin residue does not remain in the coating compound.

Preferably, a fabric, particularly a textile fabric or a fiberglass fabric, can be used as the flexible, planar substrate. A fabric is not only permeable to air and has the capacity to absorb liquids but can also additionally serve as a mechanical reinforcement in order to provide the entire structure with even better adhesion. Furthermore, the structure of the fabric leads to improved adhesion properties and is transferred to the surface of the still-viscous coating compound in Step II when the substrate is placed, the surface thereby obtaining a corresponding structure.

In an especially preferred embodiment of the method, an additional Step IV follows Step III, after the application period has expired, which is removing the flexible, planar substrate from the then-cured coating compound in order to free up its surface for further finishing, which may comprise, for example, the application of a further coating such as, for example, of laminate or gel coat or a coat of varnish. Particularly when the flexible, planar substrate is perforated or has a fabric, the substrate leaves behind a corresponding structure on the surface of the cured coating compound once it has been removed from the cured coating compound, which structure ensures especially good adhesion of a coating yet to be applied such that a corresponding pretreatment of the surface is no longer needed in order to achieve a good adhesion property, for example from roughening or grinding. To this end, preferably a peel ply or removal fabric is used as the flexible, planar substrate.

Alternatively, it is also basically conceivable, however, to leave the flexible, planar substrate on the surface of the coating compound and to then apply a further coating to the substrate in an additional Step IV, following Step III. With this alternative effect, the substrate not only acts as a reinforcement but also enables good adhesion of the further coating to then be applied, particularly when the surface of the substrate has a structure such as, for example, in the case that a perforated substrate or a fabric is used as the substrate.

A preferred exemplary embodiment of the method according to the invention is explained in greater detail in the following by means of the accompanying figures. The following is shown:

FIG. 1 a structure comprising a subsurface and a coating compound applied flatly thereupon, in a schematic sectional view;

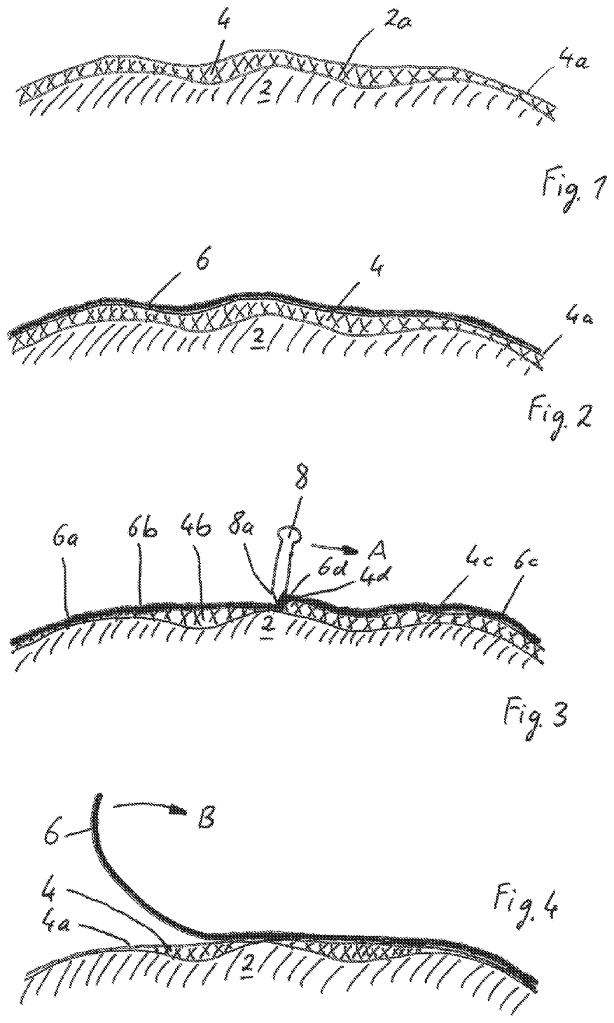

FIG. 2 the structure from FIG. 1 with a flexible, planar substrate applied to the surface of the coating compound, in the same schematic sectional view as in FIG. 1;

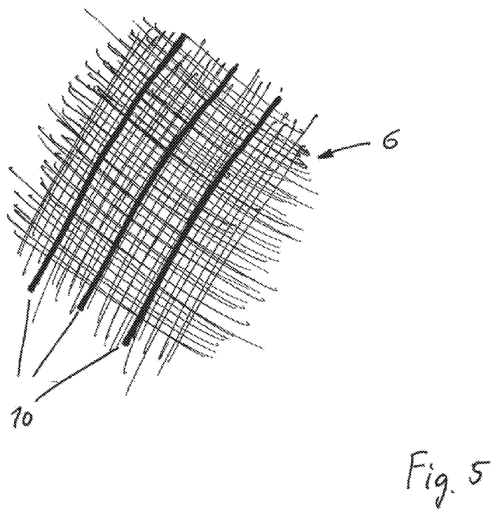

FIG. 3 the structure from FIG. 2 with a molding tool having contact with the substrate for shape-providing finishing of the still-viscous coating compound, in the same schematic sectional view as in FIG. 2;

FIG. 4 the structure from FIG. 3 with the substrate only partially separated from the coating compound which has been finished and has cured in the meantime, in the same schematic sectional view as in FIG. 3; and

FIG. 5 a schematic top view of a section of the substrate according to a preferred embodiment.

A method is described in the following for applying and molding, particularly smoothing, a moldable coating compound, which is viscous during a predetermined application period and is cured once the application period has elapsed, onto a subsurface. The coating compound is particularly used to compensate for unevenness in the subsurface in order to achieve a smooth finish. A filling compound or filler which particularly has epoxy resin, which is preferably used in yacht construction, can preferably be used as the coating compound. Thus, the method described in the following is particularly suitable for smoothing the outer skin of yachts.

FIG. 1 schematically shows the subsurface 2, onto the surface 2a of which the coating compound 4 has already been applied, in a sectional view. The application of the coating compound 4 to the subsurface 2 according to a first work step of the described method should take place without air pockets, to which end the coating compound 4 is sprayed or discharged onto the subsurface 2.

Subsequently, a flexible, planar substrate 6 is applied to the surface 4a of the coating compound in a second work step, as shown in FIG. 2.

Finishing of the structure shown in FIG. 2 takes place in a next work step with the aid of a molding tool 8, as is schematically shown in FIG. 3. In the exemplary embodiment shown, the molding tool 8 is a smoothing tool, which has an elongated body and thus is formed as a filler blade, a scraper, or a trowel and is moved in a direction transversely, preferably substantially at a right angle, as relates to its longitudinal extension, along the surface 6a of the flexible, planar substrate, as is indicated by arrow A in FIG. 3.

To this end, the lower edge 8a of the molding tool 8 is brought to bear against the surface 6a of the flexible, planar substrate 6, and pressure is exerted, by the flexible, planar substrate 6, onto the coating compound 4 underneath during the movement from the molding tool 8, in order to bring the coating compound into a required shape. Up to this point in time, the coating compound 4 is still in the viscous state such that the finishing with the molding tool 8 occurs during the application period. Preferably, the molding tool 8 is not only moved back-and-forth in a first direction according to arrow A, but also additionally in a second direction which is oriented transversely, substantially at a right angle, as relates to the first direction, whereby the coating compound 4 is pushed back-and-forth as desired and thus is kneaded until it has obtained the required shape over its entire surface 4a.

In the exemplary embodiment shown, the molding tool 8 is particularly used for smoothing the surface 4a of the coating compound 4. As can further be seen in FIG. 3, the molding tool 8 leaves behind a smoothed region 4b of the coating compound 4 in that, in this region 4b of the coating compound 4, the overlying section 6b of the flexible, planar substrate 6 was impacted with the corresponding pressure from the molding tool 8 during its movement along the surface 6a of the flexible, planar substrate 6. As can further be seen in FIG. 3, the region 4c of the coating compound 4, as viewed in the direction of movement of the molding tool 8 according to arrow A, is still untreated or non-smoothed before or upstream of the momentary position of the molding tool 8 such that the overlying section 6c of the flexible, planar substrate 6 is still following the original progression of the surface 4a of the coating compound 4. Finally, FIG. 3 schematically shows that, in the momentary state shown therein, the coating compound 4 accumulates directly before the lower edge 8a of the molding tool 8 at the point indicated by reference numeral 4d, and the flexible, planar substrate 6 obtains a correspondingly step-like or wave-shaped progression in the region indicated by reference numeral 6d. Thus, a step or wave, formed from section 4d of the coating compound 4 and the overlying section 6d of the flexible, planar substrate 6, is formed before the lower edge 8a of the molding tool 8, which step or wave is accordingly displaced as the molding tool 8 continues to move in the direction of arrow A. In this case, the flexible, planar substrate 6 prevents parts of the coating compound 4 from adhering to the lower edge 8a of the molding tool 8 and then coming back out of the surface 4a again specifically due to this adhesion.

Preferably, the flexible, planar substrate 6 should be permeable to air so that any air enclosed between the surface 4a of the coating compound 4 and the bottom of the flexible, planar substrate 6 can escape through the substrate 6, while the molding tool 8 is moved along the surface 6a of the flexible, planar substrate 6 and, in doing so, pressure is exerted onto the substrate 6 in order to shape the underlying coating compound 4, whereby any enclosed air is simultaneously pressed outward through the substrate.

The flexible, planar substrate 6 may preferably be perforated in order to achieve air permeability. Furthermore, when a material having an epoxy resin is used as the coating compound 4, the flexible, planar substrate 6 absorbs the liquid resin such that resin residue does not remain in the coating compound 4. In order to achieve the previously described properties, preferably a fabric, particularly a textile fabric or a fiberglass fabric, is used as the flexible, planar substrate 6. The reason for this is that a fabric is not only permeable to air but also can absorb liquids such that these two properties are combined in one fabric.

The work steps previously described in FIGS. 1 to 3 take place during the application period in which the coating compound 4 is in the viscous state. The coating compound 4 placed or smoothed into shape is then cured.

If the coating compound 4 is cured after the application period has expired, the flexible, planar substrate 6 is removed from the surface 4a of the coating compound 4 in a subsequent work step in the exemplary embodiment shown, as shown in FIG. 4, with the removal process taking place in the direction of arrow B in this representation. Thus, the surface 4a of the then-cured coating compound 4 is made available for subsequent finishing, which may comprise, for example, the application of a further coating such as, for example, laminate or gel coat or a coating of varnish. Particularly when the flexible, planar substrate 6 is perforated or has a fabric, the substrate 6 leaves behind a corresponding structure on the surface 4a of the cured coating compound 4, once it has been removed from the cured coating compound 4, which structure ensures especially good adhesion of a coating still to be applied. To this end, the flexible, planar substrate 6 is preferably formed as a peel ply or removal fabric.

Alternatively, it is also basically conceivable, however, that the flexible, planar substrate 6 is left on the surface 4a of the cured coating compound 4 such that it not only provides reinforcement but also good adhesion of a further coating to then be applied, particularly when the surface of the substrate 6 has a structure based on a perforation or the use of fabric.

If a coating compound which can be cured under the influence of heat is used as the coating compound 4, it is advantageous to provide the flexible, planar substrate 6 with heating media. Preferably, the heating media have electrical heating wires 10, which are inserted or incorporated into the substrate 6, as schematically shown in FIG. 5, and connected to a voltage source, which is not shown, outside of the substrate 6. Thus, in the embodiment shown in FIG. 5, the flexible, planar substrate 6 thus not only takes on the function of a protective or separating layer covering the surface 4a of the coating compound 4 for easy finishing as relates to the molding tool 8, but also simultaneously the function of providing the heat required for effective curing of the coating compound 4, and that is in the state shown in FIG. 2 and/or in the state shown in FIG. 3.

1. A method for applying and molding a moldable coating compound, which is viscous during a predetermined application period and is cured once the application period has elapsed, onto a subsurface, in particular the outer skin of a watercraft, with the steps:
I) applying the coating compound to the subsurface during the application period,
II) placing a flexible, planar substrate onto the applied coating compound during the application period, and
III) bringing a molding tool temporarily to bear on the substrate in order to bring the surface of the coating compound into a required shape during the application period,
wherein a coating compound which can be cured under the effect of heat is used as the moldable coating compound, and a substrate having a heating medium is used as the flexible, planar substrate.

2. The method according to claim 1, wherein filling compound or filler is used as the coating compound.

3. The method according to claim 1, wherein a material having an epoxy resin is used as the coating compound.

4. The method according to claim 1, wherein, in Step I, the coating compound is applied to the subsurface substantially without air pockets.

5. The method according to claim 4, wherein, in Step I, the coating compound is sprayed or discharged onto the subsurface.

6. The method for applying and smoothing a moldable coating compound according to claim 1, wherein a smoothing tool is used as the molding tool in order to smooth the surface of the coating compound.

7. The method according to claim 1, wherein, in Step III, the molding tool is moved along the substrate.

8. The method according to claim 7, wherein the molding tool is moved back-and-forth.

9. The method according to claim 7, wherein the molding tool is moved in a first direction and in a second direction oriented transversely, substantially at a right angle, as relates to the first direction.

10. The method according to claim 7, wherein an elongated body, which is moved in a direction (A) transversely, preferably substantially at a right angle, as relates to its longitudinal extension, is used as the molding tool

11. The method according to claim 10, wherein, in Step III, a filler blade, a scraper, a trowel, or a roller is used as the molding tool.

12. (canceled)

13. The method according to claim 1, wherein the heating media are activated during the application period in Step II and/or between Step II and Step III and/or in Step III and/or following Step III.

14. The method according to claim 13, wherein the heating media have electrical heating wires which are connected to a voltage source outside of the substrate.

15. The method according to claim 1, wherein a substrate permeable to air is used as the flexible, planar substrate.

16. The method according to claim 1, wherein a perforated substrate is used as the flexible, planar substrate.

17. The method according to claim 1, wherein a substrate which absorbs liquids is used as the flexible, planar substrate.

18. The method according to claim 1, wherein a fabric, particularly a textile fabric or a fiberglass fabric, is used as the flexible, planar substrate.

19. The method according to claim 1, having an additional step following Step III, which is Step IV) removing the flexible, planar substrate from the then-cured coating compound after the application period has expired.

20. The method according to claim 18, wherein a peel ply or removal fabric is used as the flexible, planar substrate.

21. The method according to claim 1, having an additional step following step III, which is Step IV) applying a further coating to the substrate.
